(19) United States
(12) Patent Application Publication
(10) Pub. No.: US 2005/0207143 A1
(43) Pub. Date: Sep. 22, 2005

(54) Flashing safety headwear

(76) Inventors: Mose L. Bishop, Jackson, MS (US); Ivan Rordell Henton, Pearl, MS (US)

Correspondence Address: Ivan Henton, 107 River Wood Pl., Pearl, MS, 39208, US

(21) Appl. No.: 11/060,688

(22) Filed: Feb. 18, 2005

Related U.S. Application Data
(60) Provisional application No. 60/547,938, filed on Feb. 27, 2004.

(51) Int. Cl. F21V 21/084

(52) U.S. Cl. 362/106

(57) ABSTRACT

The flashing safety headwear invention affixes a light assembly through underside of a cap with glue. A commercially available battery pack with switch is placed in the rear battery pouch. The batteries are connected to the lamp by wiring a series electrical circuit. Wires from the batteries serving the light and switch assembly are routed through the inner lining of the cap. The wires are then soldered to the lamp and controlled off and on by the switch. The light is intended to be used anytime visibility is restricted due to no or low light conditions, inorder to alert any person to the presence of another individual.

### CROSS REFERENCE TO RELATED APPLICATIONS

Not Applicable

### STATEMENT REGARDING FED SPONSORED R & D

Not Applicable

### REFERENCE TO SEQUENCE LISTING, A TABLE, OR A COMPUTER PROGRAM LISTING APPENDIX

Not Applicable

### BACKGROUND OF THE INVENTION

1. Field of the Invention

This invention relates to one or more lights mounted on headwear. In particular, this invention relates to one or more lights mounted on baseball-type caps.

2. Description of the Prior Art

Safety headwear is well known in the art. Typically, such devices are constructed of a material that can easily be seen during daylight hours. The devices are not typically made to increase the visibility of the wearer at night. A drawback associated with such prior art devices is the difficulty of seeing the wearer during low light conditions.

It would, therefore, be desirable to provide a device, which would increase the visibility of the wearer at night. The difficulties encountered in the prior art discussed hereinabove are substantially eliminated by the present invention.

### BRIEF SUMMARY OF THE INVENTION

In an advantage provided by this invention, a cap that allows the wearer to be visible at night.

Advantageously, this invention provides 360-degree visibility.

Advantageously, this invention provides visibility from a vertical point-of-view.

This invention is comprised of a cap, means for securing the light to the cap, and a touch sensitive switch and power source coupled to the light. The cap is designed to actuate when the switch is engaged, therefore allowing wearer to be visible during low light conditions.

### BRIEF DESCRIPTION OF THE DRAWINGS

FIG. 1 illustrates a rear perspective view of a baseball cap fitted with the light assembly of this invention

FIG. 1A illustrates the rear perspective view of the placement of the lamp

FIG. 1B illustrates placement of the battery pouch

FIG. 1C illustrates the battery pack, which is stored in FIG. 1B battery pouch

FIG. 1D illustrates the switch, which is mounted into FIG. 1C battery pack

FIG. 2 illustrates a front perspective view of a baseball cap fitted with the light assembly of this invention

FIG. 2A illustrates the front perspective view of the placement of the lamp

FIG. 2B illustrates the construction of the baseball cap

### DETAILED DESCRIPTION

The commonly manufactured baseball type cap usually consists of a fabric hat having a crown, a bill extending from the crown, a reinforcing crown liner, and an inner band extending around the circumference of the cap. The cap is manufactured with either a fixed hat size or is fitted with plastic straps at the rear of the inner band to enable adjustment of the cap's circumference. The crown is usually made of various fabrics (felt, canvas, corduroy, etc.) dyed a single color. A wide variety of logos are usually affixed to the crown. The bill is usually constructed of fabric reinforced with an inner cardboard or plastic stiffener and is made in the same color as the crown or a separate color. The bill is sometimes constructed with different colors on its top and bottom.

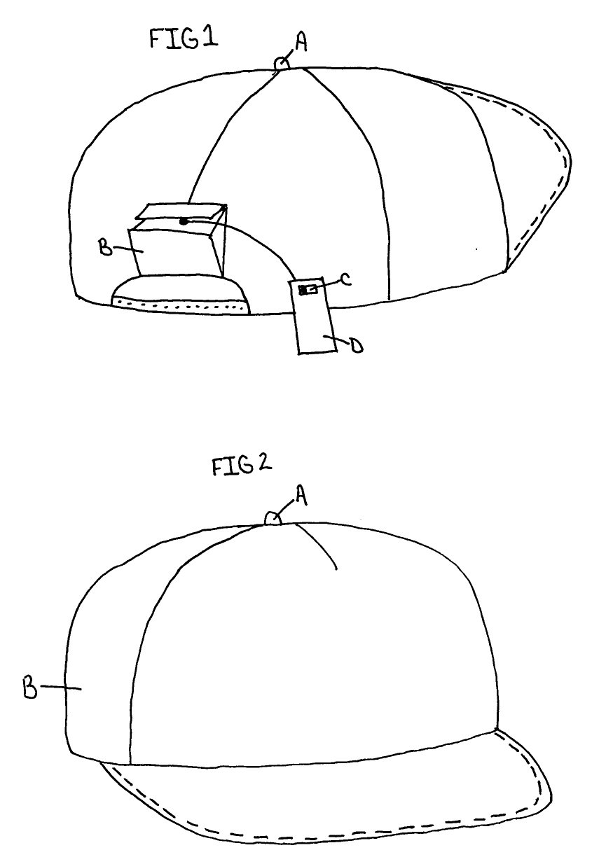

FIGS. 1A-1D depict the battery, light and switch assemblies, respectively. The flashing safety headwear invention affixes a light assembly through underside of a cap with glue. A commercially available (FIG. 1C) battery pack with switch is placed in the rear (FIG. 1B) battery pouch. The batteries are connected to the lamp by wiring a series electrical circuit. Wires from the batteries serving the light and switch assembly are routed through the inner lining of the cap. The wires are then soldered to the lamp and controlled off and on by the (FIG. 1D) switch.

The batteries are placed within the hat in most stable location. They are mounted in the (FIG. 1B) battery pouch, which is located in the center of the rear of the cap making the batteries unnoticeable to the wearer both in terms of weight and pressure on the wearer's head. The flashing safety headwear use commercially available batteries and allow the batteries to be changed easily. They are light weight and do not alter the manner in which the baseball type cap is commonly worn. The lamp(s) are mounted at the very top of the cap, which allows the (FIG. 2A) lamp to be visible for 360 degrees. The (FIG. 2A) lamp can be purchased at any electronics store.

The positve led on the battery is connected one leg of the lamp, the other leg of the lamp is then connected to either end of the switch, and the other end of the swich is connected to the negative post on the battery. The order that the components are connected is interchangable. When the components are mounted and connected to oneanother and the switch(s) is placed in the closed position, the lamp is lit. The light is intended to be used anytime visibility is restricted due to no or low light conditions, inorder to alert any person to the presence of another individual, such as when walking through a wooded area where hunters may be hunting to prevent an accidental shooting or when jogging along side the road.

While the invention has been described in what is considered its preferred embodiment, other modifications are possible to those skilled in industrial design and manufacturing production. While the preferred embodiment of the invention has been described herein, variations in the design may be made. The scope of the invention, therefore, is only to be limited by the claims appended hereto.

1. A cap having a light that provides visibility for the user of the cap, the cap comprising:
a head-engaging portion;
one or more lamps incorporated into the cap, wherein the light emitted from the cap is visible for 360 degrees.
a power source operatively associated with the light; and
an activation switch for activating and deactivating the light, wherein the activation switch is operatively associated with the light and the power source.

2. The cap of claim 1, wherein the head-engaging portion further includes a battery pouch, and wherein the battery pack is concealed within the battery pouch of the cap.

3. The cap of claim 1, wherein the battery pack contains batteries.

4. The cap of claim 1, wherein the activation switch is an on/off type switch.
